(19) United States
(12) Patent Application Publication
(10) Pub. No.: US 2021/0163194 A1
(43) Pub. Date: Jun. 3, 2021

(54) VOLATILES PRESERVING PACKAGING AND METHODS

(71) Applicant: Vireo Health Inc., Minneapolis, MN (US)

(72) Inventor: Eric Greenbaum, Denver, CO (US)

(21) Appl. No.: 17/070,846

(22) Filed: Oct. 14, 2020

Related U.S. Application Data
(63) Continuation-in-part of application No. 15/971,851, filed on May 4, 2018, now abandoned.
(60) Provisional application No. 62/501,273, filed on May 4, 2017.

(51) Int. Cl. B65D 51/28; B65D 1/10

(52) U.S. Cl. CPC B65D 51/28; B65D 1/10

(57) ABSTRACT

A packaging system and methods for the preservation of volatile chemicals in a product containing volatile chemicals is disclosed. The packaging system generally has one compartment adapted for the storage of the volatiles containing product in communication with a second compartment which contains a source of volatile chemicals such that the volatile chemicals disperse into the first compartment. The make up of the volatile chemicals in the second compartment are selected either to match the naturally occurring volatile chemicals in the product to be packaged or to complement the naturally occurring volatile chemicals in the product to be packaged. In this way, the naturally occurring volatiles content of the product can be preserved or odors and flavors that do not naturally occur within the product can be added. In some case, the product to be packaged is cannabis.

### FIELD OF THE INVENTION

The present invention relates generally to packaging for volatiles containing products, and in particular plant based products such as herbs, spices, and cannabis.

### BACKGROUND OF THE INVENTION

Cannabis for both recreational and medicinal uses is increasing in popularity in the United States and around the world. While the major cannabinoids (THC and CBD) receive most of the attention, terpenes, terpenoids, flavonoids, and other volatile (hereinafter “volatiles”) components are increasingly recognized as important. Volatiles impart flavor and aroma to cannabis and are also recognized to have important pharmacological effects. Unfortunately, by their nature, volatiles are volatile and can quickly evaporate from cannabis thereby depriving users of their benefits.

### SUMMARY OF THE INVENTION

As specified in the Background Section above, there is a need in the art to develop new devices and methods to preserve the volatile fraction in cannabis and cannabis products.

Thus, an embodiment of the present invention is a package for preserving the volatile content of a cannabis product comprising a first compartment for storing a product; a second compartment, wherein the first compartment and the second compartment are in communication via a permeable boundary, wherein the second compartment contains a source of volatile chemical compounds, and wherein the volatile compounds in the source for volatile compounds are selected to compliment the odor and or flavor of the product being stored in the first compartment. In some embodiments the package is a jar or bottle. In some embodiments the package is a bag.

In an embodiment the invention is a volatiles emitting insert for use in a cannabis product package comprising a dispersion matrix disposed within a housing wherein the dispersion matrix has been infused with a source of volatiles.

In an embodiment the invention is a method for preserving the volatiles content of a cannabis product comprising the steps of determining a mixture of volatiles that would complement the cannabis product, infusing or making a volatiles source with the mixture of volatiles that would complement the cannabis product, packaging the cannabis product with the volatiles source. In some embodiments a volatiles source is added to a packaged cannabis product after the product has been packaged either at the time of packaging or after packaging.

### BRIEF DESCRIPTION OF THE DRAWINGS:

FIG. 1 shows an example of jar holding a volatiles containing product.

FIG. 2 shows a flow diagram of a method for preserving the volatiles content of a volatiles containing product.

FIG. 3 shows an example of a jar style package for a volatiles containing product.

FIGS. 4A-B show examples of inserts for use in packages of volatiles containing products. FIG. 4A shows a dispersion matrix insert that has an adhesive component. FIG. 4B shows a dispersion matrix insert that is placed inside the package but not affixed to the package.

FIG. 5 shows another example of a jar style package for a volatiles containing product.

FIGS. 6A-G show examples of sources of volatiles for use in various embodiments of the invention. FIG. 6A shows a core disposed within a housing so that a solution of volatile chemicals can later be injected into the core. FIG. 6B shows a dispersion matrix core impregnated with solution of volatile chemicals and disposed between a top half and a bottom half of a capsule. FIG. 6C illustrates the top half and bottom half of FIG. 6B combined into a capsule. FIG. 6D shows a cross section of a capsule style insert and the dispersion matrix seated within the capsule body. FIG. 6E shows a multi-laminate sustained release device. FIG. 6F shows a dual layered design dispersion matrix with a humidity controlling element stacked below the dispersion matrix. FIG. 6G shows a humidity controlling element disposed side-by-side with the dispersion matrix.

FIGS. 7A-B show an example of a bag style package for a volatiles containing product. FIG. 7A shows an example of a bag style package incorporating a dispersion matrix insert. FIG. 7B shows an example of a bag style package with the dispersion matrix insert placed inside the bag style package.

FIG. 8 shows an illustration of the equilibrium dynamics that cause loss of volatiles in volatiles containing products.

FIG. 9 shows another example of a jar/bottle style package for a volatiles-containing product.

FIG. 10 shows a perspective view of a permeable support for a dispersion matrix insert of FIG. 9.

FIG. 11 shows a side elevational view of the permeable support of FIG. 10.

FIG. 12 shows a perspective view of a permeable support containing a dispersion matrix insert within a well portion of the support.

FIG. 13 shows a top plan view of the permeable support of FIG. 9.

FIG. 14 shows a perspective view of a permeable support according to another embodiment of the present invention.

FIG. 15 is a side elevational view of the permeable support of FIG. 14.

FIG. 16 is a top elevational view of the permeable support of FIG. 14.

FIG. 17 shows a perspective view of a permeable support containing a dispersion matrix insert within a well portion of the support of FIG. 14.

FIG. 18 shows a perspective view of a permeable support for a dispersion matrix insert according to yet another embodiment of the present invention.

### DETAILED DESCRIPTION

These and other systems, methods, objects, features, and advantages of the present disclosure will be apparent to those skilled in the art from the following detailed description of the embodiments and drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from context.

The term volatiles containing product means any product that contains volatile chemicals that are beneficial to the product and which may be lost to the environment over time thereby decreasing the value or perceived value of the product. Examples include herbs, spices, cannabis, and other natural products.

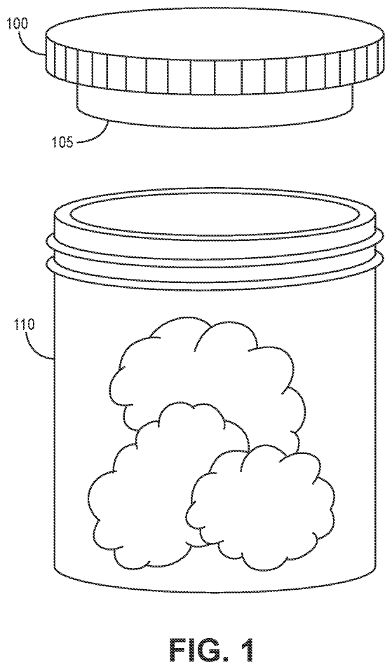

FIG. 1 shows an example of a jar-style package for a volatiles containing product. The jar-style packaging generally has a main storage compartment (110) for holding the volatiles containing product, a cap/lid (100) having an underside (105) for holding or affixing thereto a volatiles dispersion matrix.

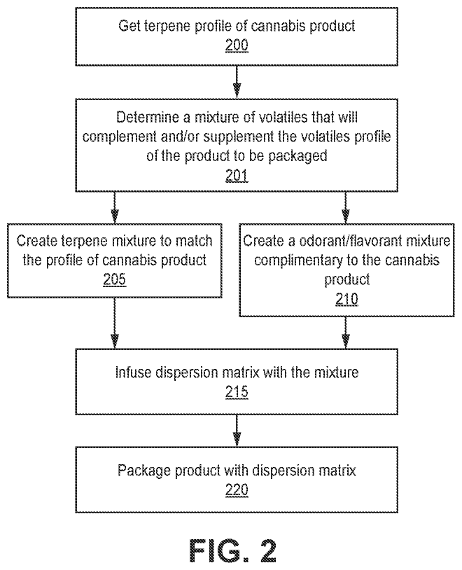

FIG. 2 shows a flow diagram of a method for preserving and/or supplementing the volatiles in a volatiles containing product. Generally the process begins by obtaining the volatiles profile of the product (200). For example if the product is cannabis, this may entail obtaining the terpene profile of the cannabis to be packaged. This can be done using standard analytical laboratory methods, such as, for example, gas chromatography mass spectrometry (GCMS). The next step is to determine or create a mixture of volatiles that will complement and/or supplement the volatiles profile of the product to be packaged (201). In some embodiments this determination may be as simple as matching the entire or part of the volatiles profile of the product to be packaged (205). In some embodiments this determination may include the identification of volatiles that supplement or complement the volatiles profile of the product. Some embodiments include the incorporation of both naturally occurring volatiles as well as volatiles that do not naturally occur in the product. The next step in the process is to create a mixture of volatiles determined in the previous step (210). This can be done by any methods known to those skilled in the art. Many volatiles are commercially available by odorant/flavorant suppliers. For example, many terpenes are available commercially. They can be mixed in the proportions desired by standard food/laboratory practices. The next part of the process is to infuse a dispersion matrix with the volatiles mixture (215). In some embodiments the dispersion matrix undergoes secondary packaging (220), such as for example in a packet or capsule. The next step in the process is to package the volatiles containing product in such a way so as the dispersion matrix is in communication with the air in the package containing the product.

In some embodiments the process is used to precisely match the volatiles profile of specific strains of cannabis. In some cases this will be a custom product for specific suppliers of unique cannabis strains. In other embodiments, the general volatiles profile of generic cannabis strains will be produced.

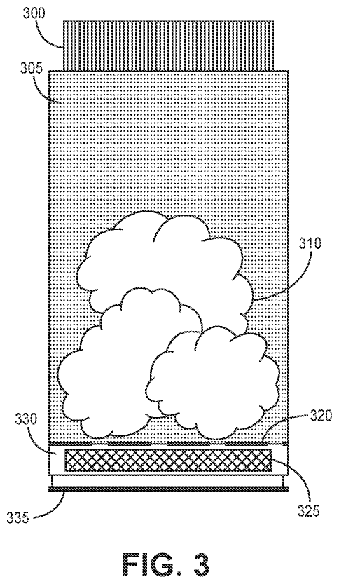

FIG. 3 shows an example of a jar style package for holding a volatiles containing product having cap/lid (300). This embodiment has a primary container portion (305) which is used to hold the volatiles containing product (310) and a secondary compartment which is used to hold the volatiles dispersion matrix (325). In this example the secondary compartment (330) is located on a bottom aspect of the jar style package. A permeable barrier (320) separates the primary container portion from the secondary compartment so the volatiles in the dispersion matrix can permeate the air in the primary container portion. A cap (335) on the bottom of the jar style package enables the placement and sealing off of the volatiles dispersion matrix.

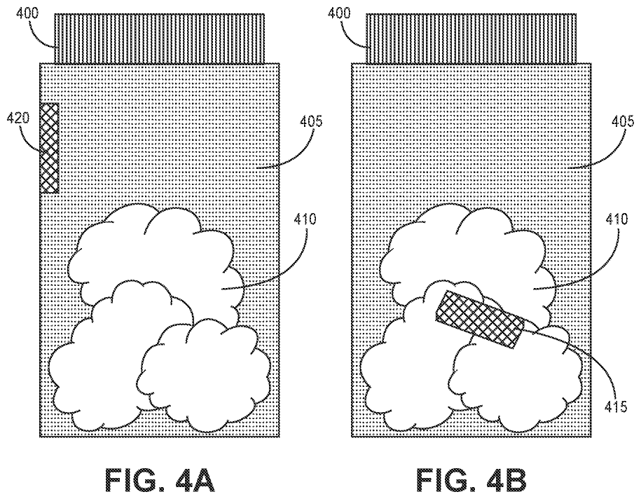

FIG. 4 shows two different embodiments of insert-style dispersion matrix insert for jar style package having cap/lid (400) and primary container portion (405). FIG. 4A shows a dispersion matrix insert that has an adhesive component (420). The adhesive component enables the dispersion matrix insert to be affixed to the inside of virtually any type of package used to hold a volatiles containing product (410). In some embodiments, the adhesive style dispersion matrix insert is affixed to the package facing surface of a cap for the package. FIG. 4B shows a dispersion matrix insert (415) that is placed inside the package but not affixed to the package. This style of dispersion matrix insert may take any form known to those having skill in the art and particularly contemplates packets and capsules.

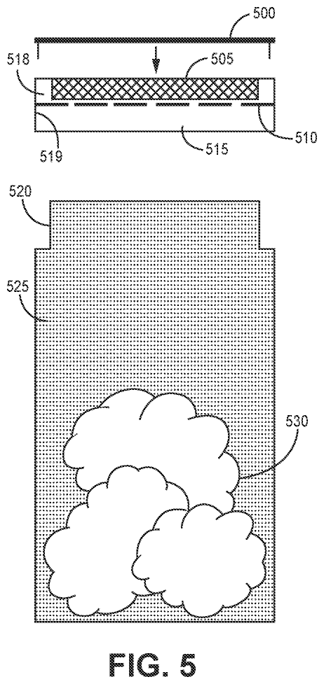

FIG. 5 shows a jar style package having primary container portion (525) in which the dispersion matrix insert (505) is disposed within a cap assembly of the jar style package. The cap comprises a package engaging portion (515), such as, for example, threads (519) that engage complementary threads (520) on the body of the jar style package; and a dispersion matrix compartment (518) adapted to house a dispersion matrix insert. A permeable layer (510) separates the dispersion matrix compartment from the package engaging portion so that the volatiles contained within the dispersion matrix can disperse into the head space of the package. A cap on the top side of the package cap (500) enables the dispersion matrix to be placed within the dispersion matrix compartment and then closed off.

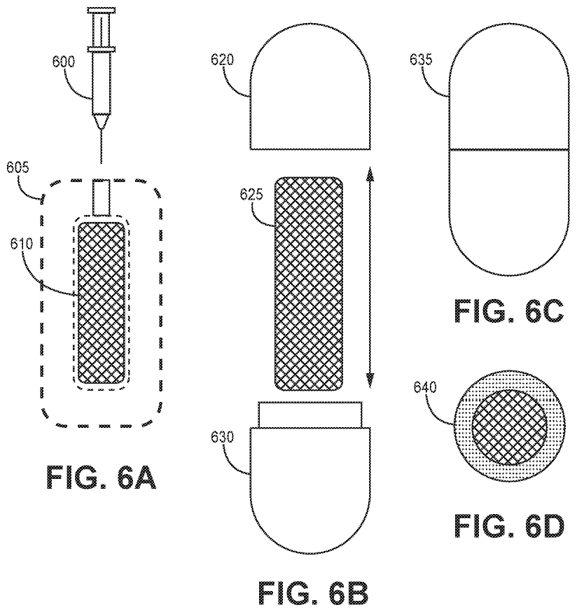

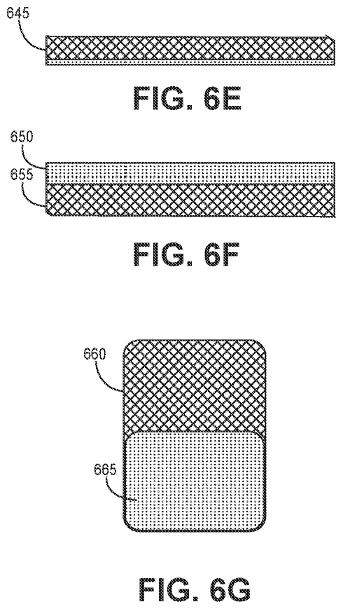

FIGS. 6A-6G show a variety of dispersion matrix inserts. In some embodiments the dispersion matrix is made up of a volatiles containing core with the core disposed within a housing and/or barrier layer. In some such embodiments, the core (610) may be manufactured within the housing (605) so that a solution of volatile chemicals can later be injected (600) into the core as shown in FIG. 6A. In some embodiments the volatiles containing core is made up of an absorbent material such as blotter paper or the like. In some embodiments the volatiles containing core is a oil based gel, in some cases that is solid or semisolid gel. In some embodiments the dispersion matrix insert is a capsule (625). In the capsule-style embodiments, a dispersion matrix core (625) is impregnated with solution of volatile chemicals and disposed between a top half (620) and a bottom half (630) of a capsule as shown in FIG. 6B. FIG. 6C illustrates the top half (620) and bottom half (630) combined into capsule (635). In FIG. 6D, a cross section of a capsule style insert (640) shows the dispersion matrix seated within the capsule body. In some embodiments the dispersion matrix insert is a packet. In some embodiments the dispersion matrix insert is a laminate. In some embodiments the dispersion matrix insert further comprises an adhesive layer so the dispersion matrix insert can be fixed to the package.

In general the dispersion matrix insert contains a material or group of materials that act as a reservoir for volatiles and release those volatiles in a controlled manner over time. These types of matrices are known in the art and practitioners will be able to select the dispersion matrix that best suits their needs. Some examples include laminates, silicone rubber matrices, polymers, and combinations thereof.

In an embodiment the dispersion matrix insert contains a hydrophobic or other absorbent material capable of absorbing an oil solution with a defined volatiles composition. In some embodiments the absorbent material includes a woven or non-woven material such as cellulose, rayon, cotton, or other polymeric material treated in such a fashion as to enable it to readily absorb oil based solutions. In some embodiments the solution treated blotter is then laminated between layers of a permeable barrier film that will transmit the volatiles. The volatiles transmission rate is determined by the type of barrier used, its thickness and porosity. The volatiles transferred is also determined by the area of the barrier exposed to the solution.

In some embodiments the dispersion matrix insert contains is a silicone rubber into which the volatiles mixture has been impregnated.

In some embodiments the dispersion matrix is a multi-laminate sustained release device capable of releasing volatiles at a controlled rate for a prolonged period of time and having a first layer of a pressure sensitive adhesive release liner for providing a protective peel strip for the device, a second layer of silicone pressure sensitive adhesive for adhering the device to a substrate to which it is applied, a third layer of a volatiles impregnated matrix of a silicone material selected from the group consisting of silicone elastomers, silicone elastomers having adhesive characteristics, and elastomeric silicone pressure sensitive adhesives, and a fourth layer of a permeable facestock backing member on the surface of the device for controlling the rate of release of the volatiles from the impregnated matrix. FIG. 6E shows a multi-laminate sustained release device (645).

In some embodiments the dispersion matrix is coupled with a humidity controlling element such as that described in US patent publication US20150328584 A1 herein incorporated by reference. In such embodiments dispersion matrix may be a dual layered design wherein the the humidity controlling element (650) may be stacked on top or below the dispersion matrix (655) as shown in FIG. 6F. In other embodiments, the humidity controlling element (665) may be disposed side-by-side with the dispersion matrix (660) as shown in FIG. 6G.

To make the volatiles solution the desired recipe/proportion of the desired volatiles is determined. This can be done by determining the volatiles profile of the product to be stored. Alternatively a de-novo volatiles profile can be created to complement the product. Next the volatiles are mixed together in the desired proportions. In some embodiments the volatiles solution is diluted into a suitable carrier, such as MCT or other inert oil. It has been observed that some individual volatiles evaporate more readily than others. In such cases it may desirable to disproportionately represent those volatiles in the matrix.

The dispersion matrix insert can include indicia disposed on an outer surface of the dispersion matrix insert covering. The indicia can include artwork, a logo, an advertisement, an instruction, a brand, a trademark, etc. The indicia can be formed by printing on an outer surface, molded into the material of the outer surface, etc.

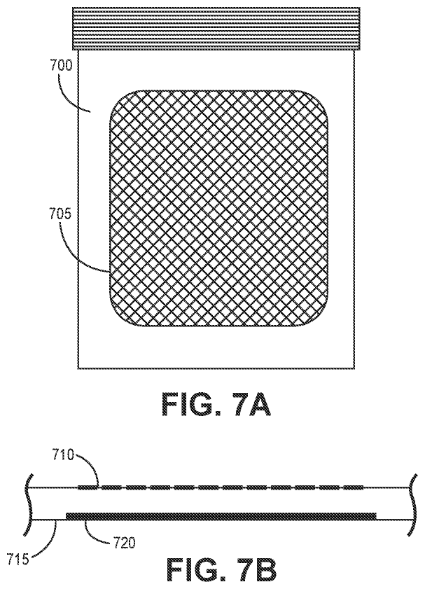

FIG. 7 shows an example of a bag style package incorporating a dispersion matrix insert. In some embodiments, as described above, the dispersion matrix insert can be placed inside the bag style package. In an embodiment the bag has a front side and a back side wherein the back side of the bag is perforated and the volatiles insert is placed over the perforations.

FIG. 7A shows an example of a bag style package (700) incorporating a dispersion matrix insert (705). In some embodiments, as described above, the dispersion matrix insert can be placed inside the bag style package as shown in FIG. 7B. In an embodiment the bag has a front side and a back side (715) wherein the back side of the bag is perforated (710) and the volatiles insert (720) is placed over the perforations.

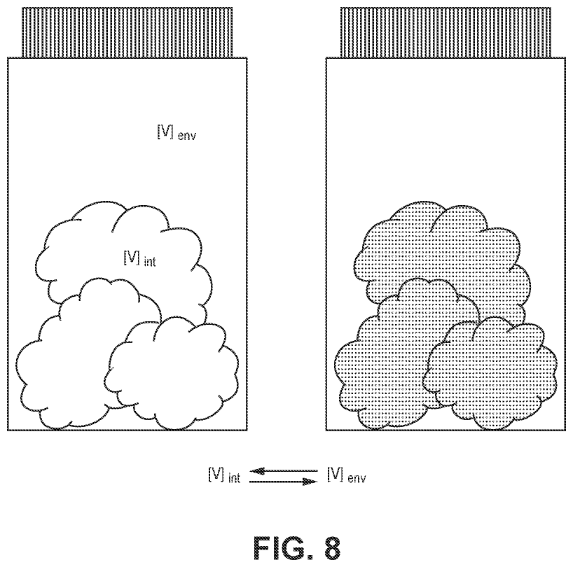

FIG. 8 is an illustration of the equilibrium dynamics between the volatile compounds in the headspace (env) and a volatiles containing product (int) that play a role in maintaining the volatiles content [V] of packaged products.

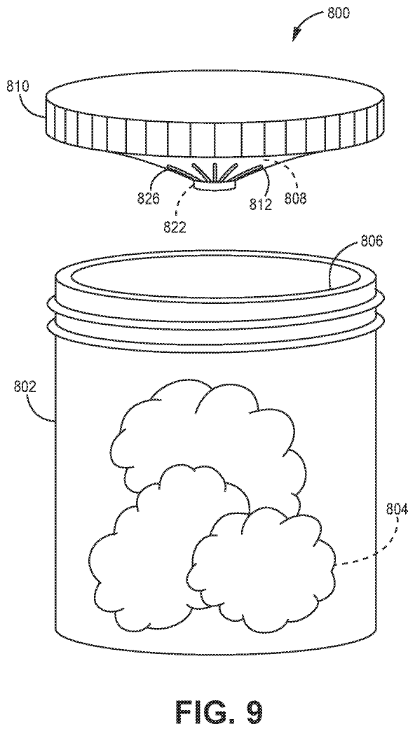

FIG. 9 shows another embodiment of the present invention. The device 800 includes a bottle 802 adapted to contain a cannabis product 804 within a main storage compartment 806. A bottle cap 810 is secured to an open end of bottle 802 to close the main storage compartment 806. A dispersion matrix compartment 808 is secured at an underside of bottle cap 810. A permeable support 812 defines a lower boundary of the dispersion matrix compartment 820. A dispersion matrix insert 822 is retained within dispersion matrix compartment 820 by the permeable support 812 and the underside of the bottle cap 810. Dispersion matrix insert 822 may include one or more sealed layers containing a terpene/volatiles mixture. In other embodiments, dispersion matrix insert 822 may be a loose mixture of terpene/volatiles-containing elements or compounds adapted to be retained within the dispersion matrix compartment 820. A plurality of apertures 826 in permeable support 812 allows for terpene/volatiles communication between the dispersion matrix compartment 808 and the cannabis product 804 contained in the main storage compartment 806. In one embodiment, the permeable support 812 is held in place against the bottle cap 810 interior when the bottle cap 810 is secured to the bottle 802.

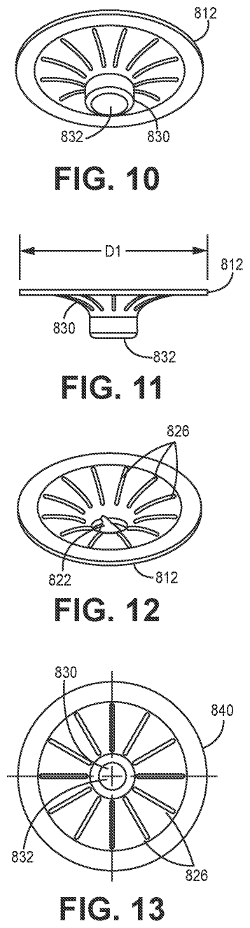

FIG. 10 shows an embodiment of permeable support 812. The dispersion matrix insert 822 (not visible in this view but shown in FIG. 12) is held within a downwardly extending well portion 830 which extends into the main storage compartment 806 when the bottle cap 810 and bottle 802 are secured together. In this embodiment, the well portion 830 includes a generally circular, central area 832 defined to be generally parallel with planes containing either the bottle cap 810 top surface and/or the bottom surface of the bottle 802. The plurality of slot apertures 826 define openings in the permeable support 812 to allow for terpene/volatiles communication across the permeable support 812. The slot apertures 826 are shown as radially extending slots centered about the downwardly extending well portion 830. The slot apertures 826 can be sized to prevent escape of the dispersion matrix insert 822 from within dispersion matrix compartment 820. FIG. 11 shows a side view of permeable support 812 having a diameter, D1, which can be sized in relation to an inner diameter of bottle cap 810 to assist in connecting the permeable support 812 at an underside of the bottle cap 810. In this embodiment, well portion 830 defines a central cup 834. In one embodiment, permeable support 812 and bottle cap 810 are held together with a friction fit, resilient latch or both. In another embodiment permeable support 812 can be adhered to bottle cap 810.

FIG. 12 is a perspective view of permeable support 812 holding a dispersion matrix insert 822 within the cup 834 within well portion 830. FIG. 13 is a top view of permeable support 812 showing radial alignment of the plurality of slot apertures 826 and central portion 832. In this embodiment, slot apertures 826 are open. In other embodiments, slot apertures 826 may include filter mesh, screen, etc., for example, to retain a loose dispersion matrix material. In one embodiment, the dispersion matrix insert 822 is sized to be received into cup 834 (not visible in this view, but see FIG. 11).

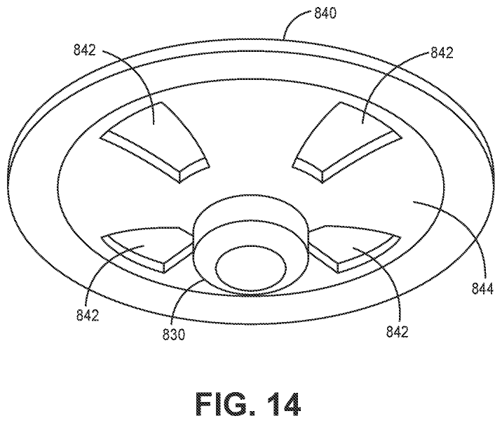

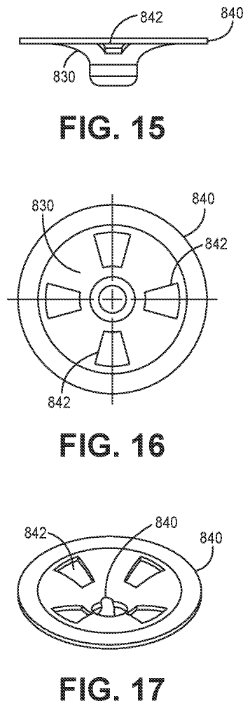

FIG. 14 through FIG. 17 illustrate views of yet another embodiment of a permeable support 840. In this example, the permeable support 840 includes four fenestrations 842 through a generally conical wall 844 of permeable support 840. The fenestrations 842 are openings centered about the downwardly extending well portion 830 adapted to support the dispersion matrix insert 822 (as shown in FIG. 17).

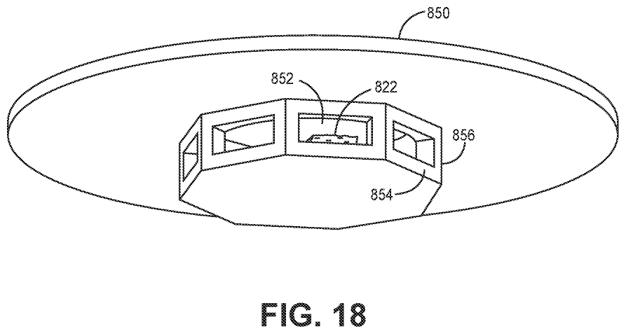

FIG. 18 illustrated another embodiment of permeable support 850. In this embodiment the fenestrations 852 are generally rectangular and are circumferentially positioned around planar wall portions 854 of downwardly extending well portion 856. The fenestrations 852 are centered around a central element adapted to support the dispersion matrix insert 822. Permeable support 850 can be friction fit, latched, adhered or otherwise secured to the bottle cap 810. In one embodiment, a method of assembly includes inserting the dispersion matrix insert 822 into the dispersion matrix compartment and then mating the permeable support 850 with the underside of the bottle in order to capture the dispersion matrix insert 822. In the embodiment of FIG. 18, the fenestrations 852 and planar wall portions 854 are generally vertical when the bottle 802 is placed on a horizontal surface. As with the earlier described embodiments, the terpenes or other volatile compounds contained within the dispersion matrix insert 822 communicate through the fenestrations 852 toward the packaged cannabis product.

While the present disclosure includes many embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

With respect to the above, it is to be understood that the invention is not limited in its application to the details of construction and to the arrangement of the components listed or the steps set forth in the description or illustrated in the drawings. The various apparatus and methods of the disclosed invention are capable of other embodiments, and of being practiced and carried out in various ways that would be readily known to those skilled in the art, given the present disclosure. Further, the terms and phrases used herein are for descriptive purposes and should not be construed as in any way limiting.

As such, those skilled in the art will appreciate that the conception upon which this disclosure is based may be utilized as a basis for designing other inventions with similar properties. It is important therefore that the embodiments, objects, and claims herein, be regarded as including such equivalent construction and methodology insofar as they do not depart from the spirit and scope of the present invention.

What is claimed is:

1. A device for containing a packaged fragrant product, said device comprising:
a bottle adapted to enclose a cannabis product within a main compartment;
a non-permeable bottle cap adapted to be secured to an open end of the bottle to close the main compartment, with a dispersion matrix compartment at an underside of the bottle cap, and with a permeable support defining a lower boundary of the dispersion matrix compartment; and
a dispersion matrix insert being retained within the dispersion matrix compartment of the bottle cap by the permeable support, with the dispersion matrix insert containing terpenes or other volatiles which communicate through apertures in the permeable support and into the main compartment of the bottle to interact with the cannabis product.

2. The device of claim 1 wherein the bottle cap is threadedly secured to the bottle to close the main compartment.

3. The device of claim 1 wherein the permeable support defines a downwardly extending well portion for supporting the dispersion matrix insert within the main compartment, wherein the dispersion matrix insert is removed from the main compartment by removing the bottle cap.

4. The device of claim 1 wherein the dispersion matrix unit includes an absorbent material containing an oil solution with a volatile composition including the terpenes.

5. The device of claim 1 wherein the dispersion matrix insert contains primarily terpenes selected to complement a flavor or odor of the cannabis product.

6. The device of claim 5 wherein the dispersion matrix insert is a packet or pouch.

7. The device of claim 6 wherein the dispersion matrix insert is sized to be received into a cup defined at a lower end of the permeable support.

8. The device of claim 1 wherein the apertures in the permeable support are a plurality of radially-aligned slot apertures.

9. The device of claim 1 wherein the permeable support is includes a cup structure for receiving at least a portion of the dispersion matrix insert, wherein the cup structure extends inwardly toward a bottom of the bottle when the bottle cap is secured to the bottle.

10. A package device for containing a product, said device comprising:
a bottle having a main compartment for storing a volatiles containing product; and
a cap adapted to be secured to the bottle for closing the main compartment, with the cap including a dispersion matrix unit compartment, wherein the main compartment and the dispersion matrix unit compartment are in communication across a permeable support secured to an underside of the cap, wherein the dispersion matrix unit compartment contains a dispersion matrix insert providing a source of volatile chemical compounds, and with the permeable support maintaining the dispersion matrix insert in the cap, and wherein the volatile chemical compounds are selected to compliment an odor or a flavor or both of the volatiles containing product being stored in the main compartment.

11. The device of claim 10 wherein the permeable support defines a downwardly extending well portion for supporting the dispersion matrix insert within the main compartment, wherein the dispersion matrix insert is removed from the main compartment by removing the bottle cap.

12. The device of claim 10 wherein the dispersion matrix unit includes an absorbent material containing an oil solution with a volatile composition including the terpenes.

13. The device of claim 10 wherein the dispersion matrix insert contains primarily terpenes selected to complement a flavor or odor of the cannabis product.

14. The device of claim 13 wherein the dispersion matrix insert is a packet or pouch.

15. The device of claim 14 wherein the dispersion matrix insert is sized to be received into a cup defined at a lower end of the permeable support.

16. A device for containing a fragrant product, comprising:
a bottle holding a cannabis product;
a non-permeable bottle cap adapted to be secured to an open end of the bottle, with said bottle cap defining a dispersion matrix compartment within the cap, and with a permeable support defining a lower boundary of the dispersion matrix compartment; and
a dispersion matrix insert having a volatiles-containing product, with the volatiles-containing product being a source of odorant/flavorants complementary to the cannabis product and absorbed into an absorbent material of the dispersion matrix insert, and wherein the dispersion matrix insert is retained within the dispersion matrix compartment of the cap by the permeable support.

17. The device of claim 16 wherein the permeable support defines a downwardly extending well portion for supporting the dispersion matrix insert within the main compartment, wherein the dispersion matrix insert is removed from the main compartment by removing the bottle cap.

18. The device of claim 16 wherein the dispersion matrix insert is a packet or pouch.

19. The device of claim 18 wherein the dispersion matrix insert is sized to be received into a cup defined at a lower end of the permeable support.

20. The device of claim 19 wherein the permeable support includes a plurality of apertures allowing communication between the dispersion matrix compartment and contents of the bottle.
